(19) United States
(12) Patent Application Publication
(10) Pub. No.: US 2026/0042381 A1
(43) Pub. Date: Feb. 12, 2026

(54) LONG SLIDE RAIL SYSTEM FOR VEHICLE SEAT

(71) Applicant: HYUNDAI TRANSYS INC., Seosan-si (KR)

(72) Inventors: Cheon KIM, Hwaseong-si (KR); Seong Jun HWANG, Hwaseong-si (KR); Heoung Su LIM, Hwaseong-si (KR); Kyeong Ho SEO, Suwon-si (KR); Jung Hyun HAN, Hwaseong-si (KR)

(21) Appl. No.: 19/289,650

(22) Filed: Aug. 4, 2025

(30) Foreign Application Priority Data
Aug. 7, 2024 (KR) 10-2024-0105169

(51) Int. Cl. B60N 2/08; B60N 2/07

(52) U.S. Cl. CPC B60N 2/0837; B60N 2/07; B60N 2/0806

(57) ABSTRACT

A long slide rail system for a vehicle seat, includes a lower rail extending lengthwise along a vehicle floor panel, the lower rail being fixedly installed on the floor panel, an upper rail coupled to the lower rail and configured for a seat cushion to be slidably moved along the lower rail, a locking module mounted on the upper rail, where the upper rail is slidably movable based on the locking module being unlocked from a locking hole, a fixing guide coupled to the upper rail so as to be spaced apart from the locking module, and a moving guide coupled to the locking module and disposed to face the fixing guide, where the moving guide is selectively connected to the fixing guide based on the locking module being locked on the locking hole so as to control horizontal and vertical clearances with respect to the upper rail.

### CROSS-REFERENCE TO RELATED APPLICATION

This application claims priority, under 35 U.S.C. § 119(a), to Korean Patent Application No. 10-2024-0105169, filed on Aug. 7, 2024, the entire contents of which are incorporated herein by reference.

### BACKGROUND

### (a) Technical Field

The present disclosure relates to a long slide rail system for a vehicle seat, and more particularly, to a long slide rail system for a vehicle seat, configured to prevent movement of the vehicle seat by restricting a vertical clearance and a horizontal clearance between a lower rail and an upper rail.

### (b) Background Art

In general, a vehicle seat includes a seatback and a seat cushion and is mounted on a seat sliding device configured to allow the seat cushion to be slidably moved in the forward-and-rearward direction of a vehicle body.

Normally, a front seat is mounted on a sliding device formed to have a short longitudinal length and configured to provide a short forward-and-rearward movement distance. Conversely, in the case of recreational vehicles (RVs) and vans having a larger vehicle body and a larger floor panel than those of passenger cars, a sliding device formed to have a long longitudinal length is installed therein to increase a degree of adjustment for a forward-and-rearward movement distance of a vehicle seat. Accordingly, sufficient leg room for a passenger may be secured, and a comfortable interior living space may be provided.

Typically, a long slide rail system is configured to provide a longer forward-and-rearward movement distance (approximately 400 to 1,000 mm) than a forward-and-rearward movement distance (approximately 200 to 300 mm) of a short slide rail system. Further, the long slide rail system is configured to include a lower rail embedded and mounted in a floor panel of a vehicle, and an upper rail connected to the lower rail so as to be movable along the lower rail in the forward-and-rearward direction and configured to be assembled with a vehicle seat.

In the long slide rail system, as the length of the lower rail increases, the dimensions of each section of the long slide rail system may not be constant. Accordingly, the following problems may occur due to a dimensional distribution.

First, since the upper rail is assembled with the lower rail where a dimensional distribution of each section is present, clearances present in some sections may be secured, but clearances present in other sections may not be reliably secured due to a dimensional distribution. In this case, vibration and shaking of the upper rail may occur when the upper rail slidably moves along the lower rail.

Second, since the dimensions of each section of the lower rail are not constant, a degree of coupling between the lower rail and a clearance-controlling member such as a roller or an injection-molded product may vary in each section, leading to a difference in operating force when the upper rail slidably moves along the lower rail. Accordingly, customers may have an unsatisfactory operational feeling when operating a seat, and thus marketability of the seat may deteriorate. As a result, it is difficult to improve marketability and quality of the seat due to the above-described problems.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an aspect of the present disclosure to provide a long slide rail system for a vehicle seat, configured to prevent vertical movement and horizontal movement of the vehicle seat in a fixed state in such a manner that a rotation bracket is rotated by elastic force when a locking module is located to be caught by a lower rail, a moving guide connected to the rotation bracket is slidably moved toward a fixing guide so as to be mounted on the fixing guide, and a vertical clearance and a horizontal clearance of an upper rail with respect to the lower rail are controlled by the shapes of the fixing guide, formed to be inclined in the vertical and horizontal directions, respectively.

In one aspect, the present disclosure provides a long slide rail system for a vehicle seat, the long slide rail system including a lower rail extending lengthwise along a floor panel of a vehicle, the lower rail being fixedly installed on the floor panel, an upper rail coupled to the lower rail, the upper rail being configured to enable a seat cushion to be slidably movable along the lower rail, a locking module mounted on the upper rail, where the upper rail is slidably moved based on the locking module being unlocked from a locking hole formed on the lower rail, a fixing guide coupled to the upper rail so as to be spaced apart from the locking module, and a moving guide coupled to the locking module and disposed to face the fixing guide, where the moving guide is selectively connected to the fixing guide based on the locking module being locked on the locking hole so as to control a horizontal clearance and a vertical clearance with respect to the upper rail.

In a preferred embodiment, a pair of the fixing guides may be provided on forward-and-rearward directions relative to the locking module.

In another preferred embodiment, the fixing guide may be selectively provided either forwardly or rearwardly of the locking module.

In still another preferred embodiment, the fixing guide may include a main body fixedly coupled to the upper rail, a pair of first support members formed to face each other, and to extend perpendicularly from the main body, and a pair of second support members formed to face each other, and to extend perpendicularly from the main body and disposed to be spaced apart lengthwise from the respective first support members.

In yet another preferred embodiment, each of the first support members may have an upper surface formed to be inclined.

In still yet another preferred embodiment, the second support members may be disposed forwardly of the respective first support members in a forward direction of the moving guide and may be disposed to be inclined such that a gap formed between the second support members gradually increases in the forward direction of the moving guide.

In a further preferred embodiment, the moving guide may include a rotation bracket rotatably coupled to the locking module so as to face the fixing guide, and a guide bracket rotatably coupled to the rotation bracket, wherein the guide bracket is formed to be selectively moved in conjunction with rotation of the rotation bracket so as to be connected to the first support members and the second support members.

In another further preferred embodiment, the rotation bracket may be configured to rotate in conjunction with rotation of the locking module upon the locking module being rotated to be unlocked from the locking hole, and may be connected to the upper rail by an elastic member so as to elastically maintain a position of the guide bracket connected to the first support members and the second support members.

In still another further preferred embodiment, the rotation bracket may include a protruding member formed to protrude toward the locking module.

In yet another further preferred embodiment, the guide bracket may include a body portion connected to the main body of the fixing guide, the body portion configured to be movable in forward-and-rearward directions, first mounting portions disposed laterally of the body portion, the first mounting portions configured to be selectively connected to the respective first support members, and second mounting portions connected to the body portion, the second mounting portions configured to be selectively connected to the respective second support members.

In still yet another further preferred embodiment, the first mounting portions may include connecting members each formed to have an L-shape, the connecting members configured to support the respective first support members, and roller members coupled to outer surfaces of the respective connecting members so as to contact an upper surface of the lower rail.

In a still further preferred embodiment, the second mounting portions may be respectively connected to a left side and a right side of the body portion by elastic members and may extend toward front sides of the respective first mounting portions, and the second mounting portions may be formed to be pressed by the respective roller members so as to be elastically moved in a direction that allow the second mounting portions to be connected to the respective second support members.

In a yet still further preferred embodiment, each of the second mounting portions may include a rubber member couple to an outer surface thereof so as to contact a side surface of the lower rail.

In another preferred embodiment, the body portion may include an elastic member connected to the main body and disposed on a front side of the body portion, the elastic member being configured to selectively provide, to the body portion, elastic restoring force in a compressed state based on the body portion being moved toward the fixing guide.

Other aspects and preferred embodiments of the disclosure are discussed infra.

It is understood that the terms “vehicle”, “vehicular”, and other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIGS. 1 and 2 are views each showing a long slide rail system for a vehicle seat according to an embodiment of present closure;

FIG. 3 is a view showing a state in which a horizontal clearance and a vertical clearance of a moving guide are controlled in the long slide rail system for a vehicle seat according to the embodiment of the present disclosure;

FIG. 4 is a view showing a state in which the moving guide is separated from the long slide rail system for a vehicle seat according to the embodiment of the present disclosure;

FIGS. 5 and 6 are views each showing an operating state of the moving guide according to rotation of a rotation bracket in the long slide rail system for a vehicle seat according to the embodiment of the present disclosure;

FIGS. 7A and 7B are views each showing a fixing guide in the long slide rail system for a vehicle seat according to the embodiment of the present disclosure; and

FIGS. 8 to 13 are views each showing an operating state of the moving guide in the long slide rail system for a vehicle seat according to the embodiment of the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, a preferred embodiment according to the present disclosure will be described in detail with reference to the accompanying drawings.

Advantages and features of the present disclosure and methods of achieving the same will become more apparent with reference to the embodiments described below in detail and the accompanying drawings.

However, the present disclosure is not limited by the embodiments disclosed below, and may be implemented in various forms. The embodiments are provided to make the present disclosure complete, and to fully inform those skilled in the art to which the present disclosure pertains of the scope of the disclosure, and the present disclosure is only defined by the scope of the claims.

In describing the embodiments disclosed herein, when it is determined that a detailed description of publicly known techniques to which the disclosure pertains may obscure the gist of the present disclosure, detailed description thereof will be omitted.

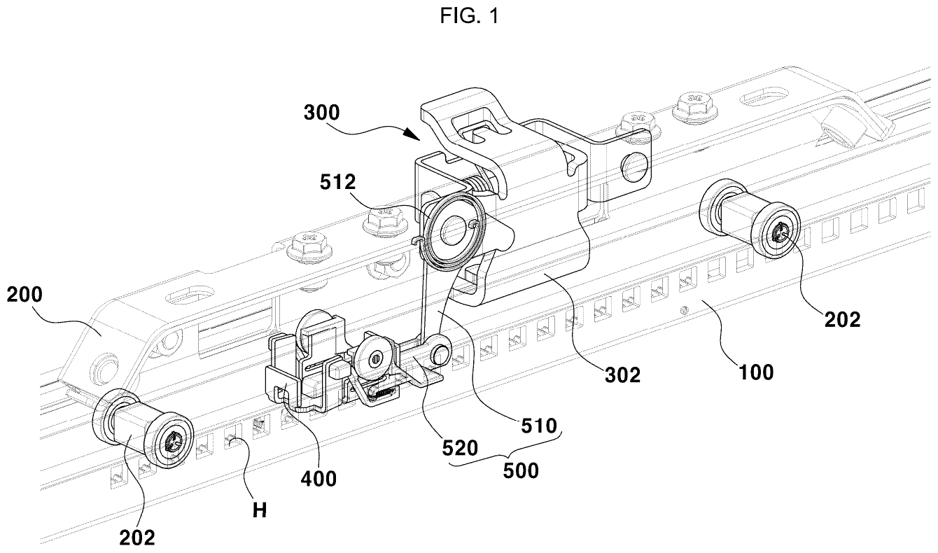

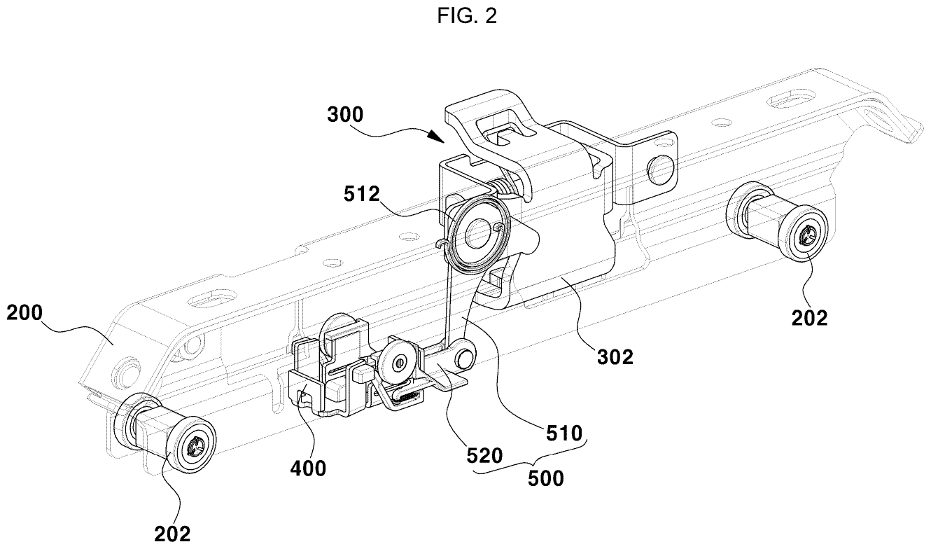

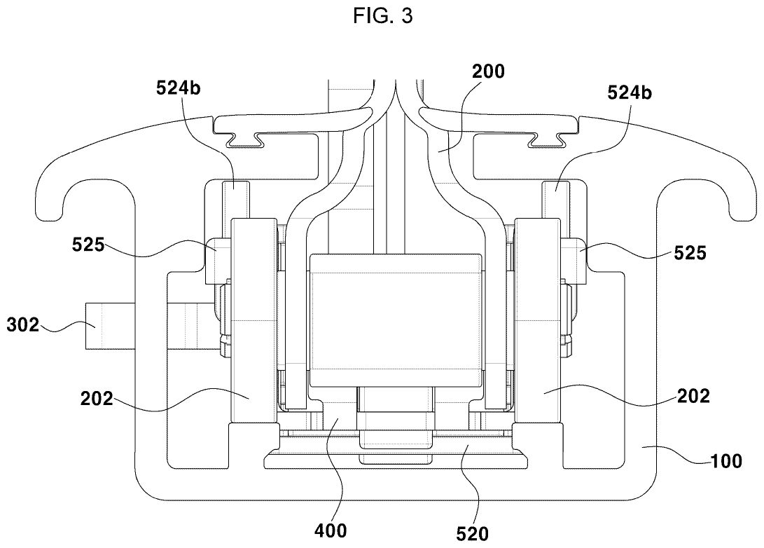

FIGS. 1 and 2 are views each showing a long slide rail system for a vehicle seat according to an embodiment of present closure, and FIG. 3 is a view showing a state in which a horizontal clearance and a vertical clearance of a moving guide are controlled in the long slide rail system for a vehicle seat according to the embodiment of the present disclosure.

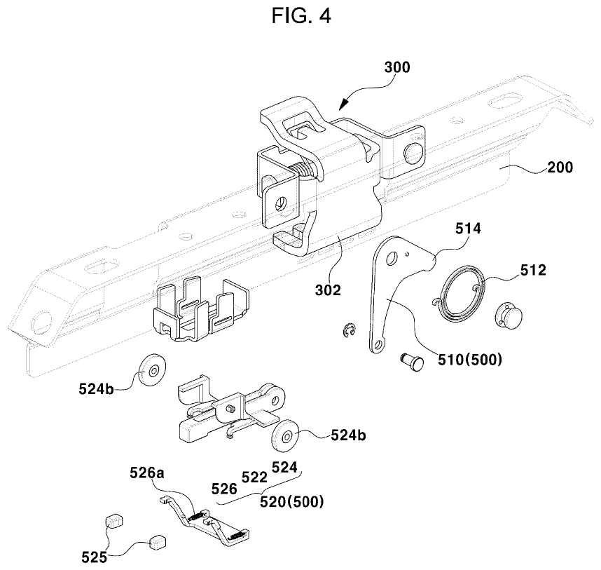

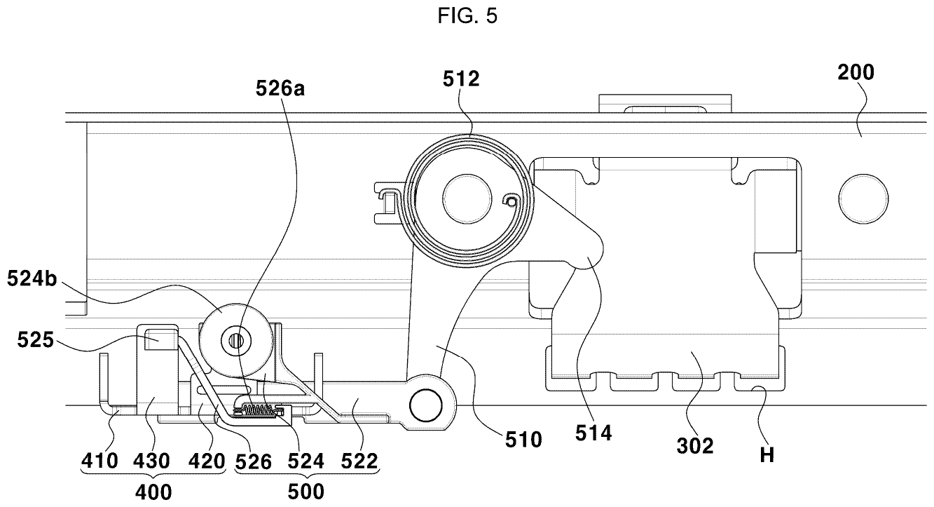

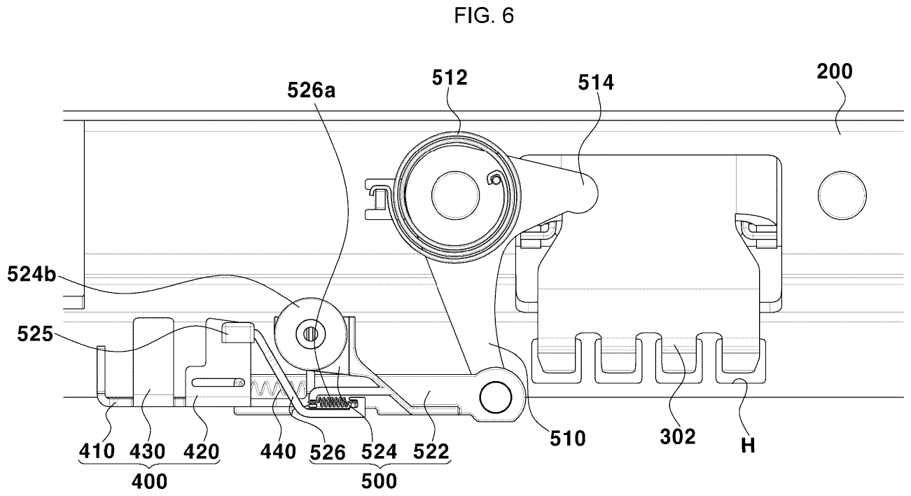

FIG. 4 is a view showing a state in which the moving guide is separated from the long slide rail system for a vehicle seat according to the embodiment of the present disclosure, and FIGS. 5 and 6 are views each showing an operating state of the moving guide according to rotation of a rotation bracket in the long slide rail system for a vehicle seat according to the embodiment of the present disclosure.

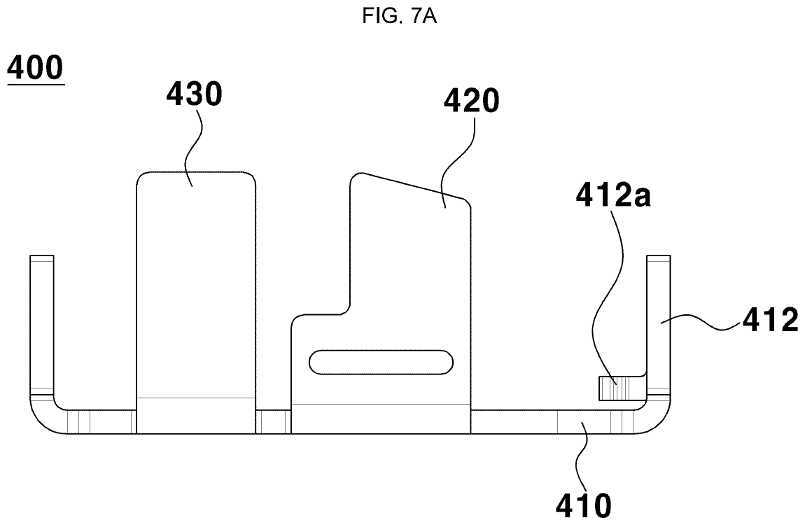

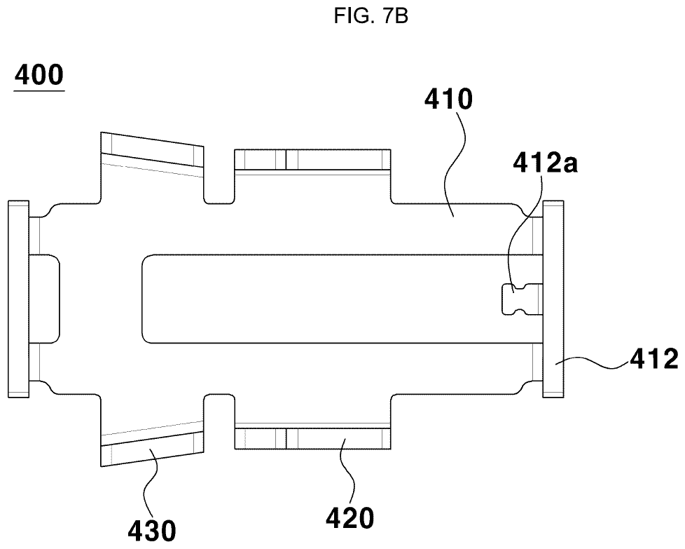

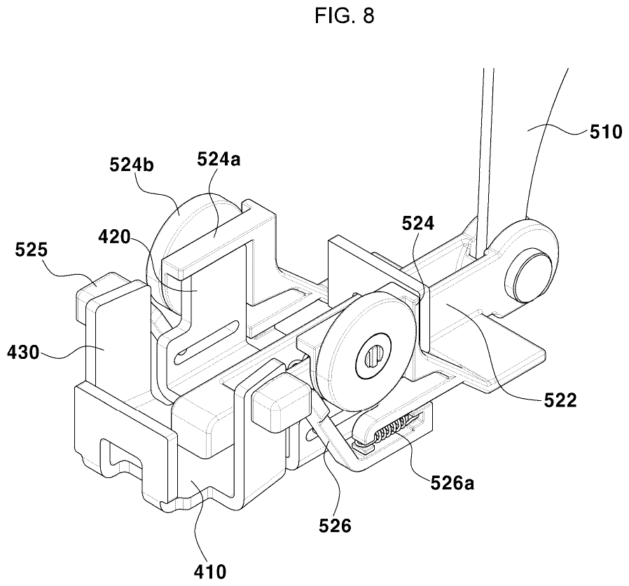

FIGS. 7A and 7B are views each showing a fixing guide in the long slide rail system for a vehicle seat according to the embodiment of the present disclosure, and FIGS. 8 to 13 are views each showing an operating state of the moving guide in the long slide rail system for a vehicle seat according to the embodiment of the present disclosure.

As shown in FIGS. 1 and 2, the long slide rail system for a vehicle seat according to the present embodiment includes a lower rail 100, an upper rail 200, a locking module 300, a fixing guide 400, and a moving guide 500.

The lower rail 100 extends lengthwise along a floor panel of a vehicle and is fixedly installed on the floor panel.

The upper rail 200 is coupled to the lower rail 100, and a seat cushion constituting a vehicle seat is coupled to the upper rail 200 so as to be slidably movable along the lower rail 100.

To this end, the upper rail 200 may include a plurality of rollers 202, and the upper rail 200 may be slidably movable in the forward-and-rearward direction of the lower rail 100 via the rollers 202.

Further, the locking module 300 includes a lock fork 302. The lock fork 302 is vertically rotatably mounted on the upper rail 200. When the lock fork 302 is rotated to be unlocked from a locking hole H formed in the lower rail 100, the upper rail 200 may be slidably moved.

More specifically, in a locking mode of the vehicle seat, the lock fork 302 is located to be locked in the locking hole H so as to restrict sliding movement of the upper rail 200, and in a moving mode of the vehicle seat, the lock fork 302 is unlocked from the locking hole H through axial rotation thereof on the upper rail 200 so as to enable sliding movement of the upper rail 200.

The fixing guide 400 accommodates a lower portion of the upper rail 200 therein and is fixedly coupled thereto by welding or the like.

A pair of fixing guides 400 is provided, and the fixing guides 400 are spaced apart from each other in the forward-and-rearward direction of the locking module 300.

Here, as shown in FIGS. 1 and 2, the fixing guide 400 may be selectively provided either forwardly or rearwardly of the locking module 300 and may be disposed to face one moving guide 500.

As described, in the present embodiment, one fixing guide 400 and one moving guide 500 are provided. Accordingly, compared to a structure including a pair of fixing guides 400 and a pair of moving guides 500, it is possible not only to reduce costs, but also to effectively control a horizontal clearance and a vertical clearance of the upper rail 200.

As shown in FIGS. 7A and 7B, the fixing guide 400 includes a main body 410, a first support member 420, and a second support member 430.

The main body 410 has a connecting member 412 configured for the moving guide 500 to be connected thereto and formed to stand upright therefrom, and is fixedly coupled to the upper rail 200.

Here, as shown in FIG. 6, a fixing member 412a is formed to protrude from the connecting member 412 and is configured to fix an elastic member 440 (refer to FIG. 6). Since the fixing member 412a may fix the position of the elastic member 440 accommodated in a body portion 522 of the moving guide 500, elasticity may be selectively provided to the moving guide 500, the movement of which is determined by the moving mode or the locking mode.

A pair of first support members 420 is provided. Here, the first support members 420 are formed to extend perpendicularly from the main body 410 and are located to face each other on both side surfaces of the main body 410 in a parallel manner.

Each of the first support members 420 may be formed to have a predetermined length and extend in the height direction thereof. Preferably, the upper surface of each of the first support members 420 may be formed to be gradually inclined in a direction in which the moving guide 500 is moved forward (refer to FIG. 7A).

A pair of second support members 430 is formed to be spaced apart lengthwise from the first support members 420. Further, the second support members 430 are formed to extend perpendicularly from the main body 410 and are located to substantially face each other not entirely parallel to one another.

Preferably, the second support members 430 may be disposed to be inclined in a direction in which the second support members 430 are spaced apart from each other on the side surfaces of the main body 410. More preferably, a gap formed between the second support members 430 may gradually increase in a direction in which the moving guide 500 is moved forward (refer to FIG. 7B).

Meanwhile, the moving guide 500 is selectively moved when the lock fork 302 is located to be locked in the locking hole H and then is connected to the first support member 420 and the second support member 430. Thereafter, as shown in FIG. 3, the moving guide 500 is formed to control, inside the lower rail 100, a horizontal clearance and a vertical clearance with respect to the upper rail 200.

The number of moving guides 500 is the same as the number of fixing guides 400. As described above, when a pair of fixing guides 400 is coupled to a pair of moving guides 500, a pair of moving guides 500 may be rotatably coupled to the lock fork 302. Alternatively, when one fixing guide 400 is coupled to one moving guide 500, one moving guide 500 may be rotatably coupled to the lock fork 302.

The moving guide 500 may include a rotation bracket 510 and a guide bracket 520, as shown in FIG. 4.

Here, the rotation bracket 510 is rotatably axially coupled to the locking module 300 in a Direction Facing the Fixing Guide 400.

When the lock fork 302 is unlocked from the locking hole H in the moving mode, the rotation bracket 510 may be axially rotated to temporarily elastically move the guide bracket 520 in a direction in which the guide bracket 520 is disconnected from the first support member 420 and the second support member 430.

To this end, the rotation bracket 510 is connected to the upper rail 200 by an elastic member 512 made of a restoring spring, and the position of the guide bracket 520 connected to the first support member 420 and the second support member 430 may be elastically maintained by the elastic member 512.

In other words, according to elastic force applied from the elastic member 512 to the rotation bracket 510, in the locking mode, as shown in FIG. 5, the rotation bracket 510 elastically supports the guide bracket 520 so as to allow the guide bracket 520 to be connected to the fixing guide 400, and in the moving mode, as shown in FIG. 6, the rotation bracket 510 elastically supports the guide bracket 520 so as to allow the guide bracket 520 to be temporarily disconnected from the fixing guide 400 in a state in which the rotation bracket 510 is rotated by the locking module 300 and elastic restoring force is applied to the rotation bracket 510.

Here, the rotation bracket 510 is provided with a protruding member 514 formed to protrude toward the locking module 300. When the lock fork 302 is rotated to switch from the locking mode to the moving mode, the protruding member 514 is pressed by the rotating lock fork 302 such that the rotation bracket 510 is rotatably moved to enable movement of the guide bracket 520.

As shown in FIG. 4, one side of the guide bracket 520 is rotatably connected to the rotation bracket 510, and the other side thereof is connected to the connecting member 412. In the locking mode, the guide bracket 520 is selectively connected to the first support member 420 and the second support member 430.

This guide bracket 520 includes a body portion 522, a first mounting portion 524, and a second mounting portion 526.

The body portion 522 is connected to the connecting member 412 of the main body 410 and is formed to be movable in the forward-and-rearward direction.

The first mounting portion 524 is disposed laterally of the body portion 522 and is formed to be selectively connected to the first support member 420.

More specifically, the first mounting portion 524 extends in a diagonal direction so as to be inclined upwards in the leftward-and-rightward direction of the body portion 522. Further, the first mounting portion 524 includes a connecting member 524a selectively connected to the first support member 420 and a roller member 524b.

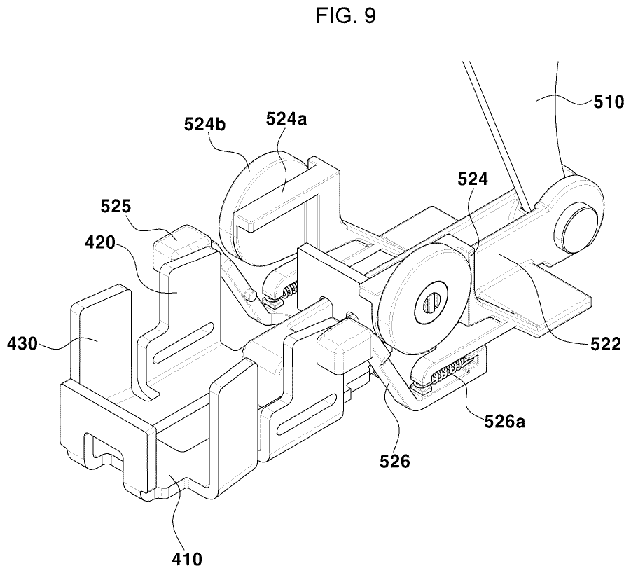

As shown in FIGS. 8 and 9, the connecting member 524a is formed to have an L-shape to support the first support member 420.

The upper surface of the first support member 420 is formed to be gradually inclined upwards (refer to FIG. 7A). Accordingly, when the body portion 522 is moved due to switching to the locking mode, the connecting member 524a is moved along the inclined surface of the first support member 420 in a state of supporting the upper surface of the first support member 420, and thus the roller member 524b may contact the upper surface of the lower rail 100.

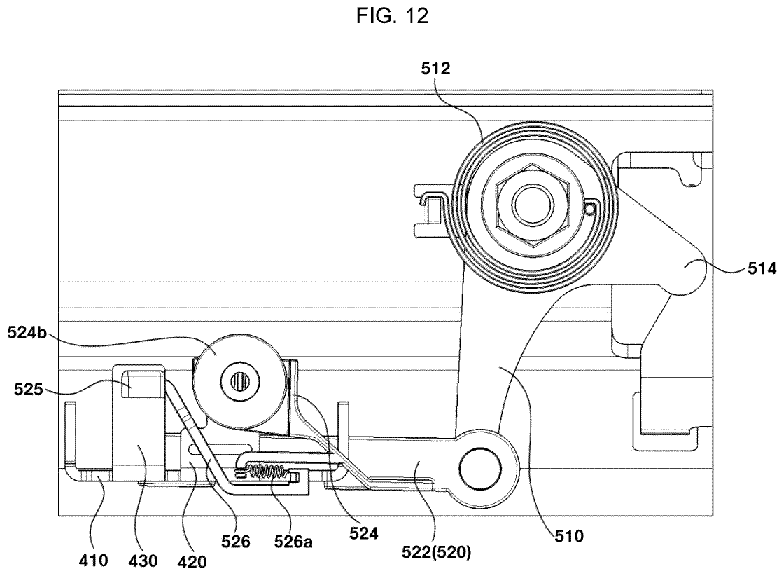

That is, the roller member 524b is coupled to the outer surface of the connecting member 524a so as to contact the upper surface of the lower rail 100, and as shown in FIG. 12, when the connecting member 524a is moved along the upper surface of the first support member 420 in the locking mode, a vertical clearance of the moving guide 500 with respect to the fixing guide 400 is controlled along with the roller 202 (refer to FIG. 3). As a result, a vertical clearance with respect to the upper rail 200 is controlled.

The second mounting portion 526 is connected to the body member 522 and is formed to be selectively connected to the second support member 430.

Preferably, the second mounting portion 526 may be made of an elastic material such that, when the second mounting portion 526 is connected to the second support member 430, the second mounting portion 526 may be opened by a predetermined range corresponding to the shape of the second support member 430 (refer to FIG. 7B).

The second mounting portion 526 may have a rubber member 525 mounted thereon, and the rubber member 525 is coupled to the outer surface of the second mounting portion 526 so as to be in contact with the side surface of the lower rail 100 (refer to FIG. 3). Here, in the locking mode, the first mounting portion 524 is connected to the first support member 420 to control a vertical clearance of the moving guide 500 with respect to the fixing guide 400, and a horizontal clearance of the moving guide 500 with respect to the fixing guide 400 is also controlled. As a result, a horizontal clearance with respect to the upper rail 200 is controlled.

As shown in FIGS. 8 and 9, the second mounting portions 526 are respectively connected to the left and right sides of the body portion 522 by elastic members 526a and are formed to extend toward the front side of the first mounting portion 524. Further, when pressed by the roller members 524b, the second mounting portions 526 are formed to be elastically moved in a direction in which the second mounting portions 526 are additionally connected to the respective second support members 430.

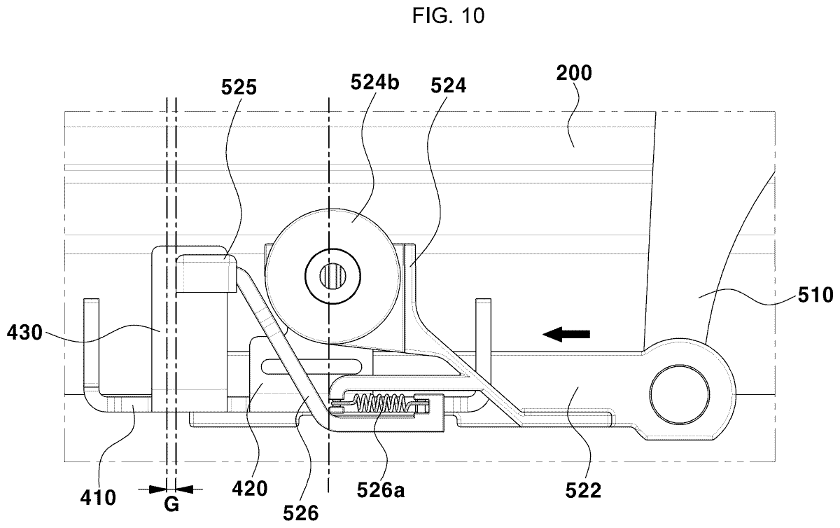

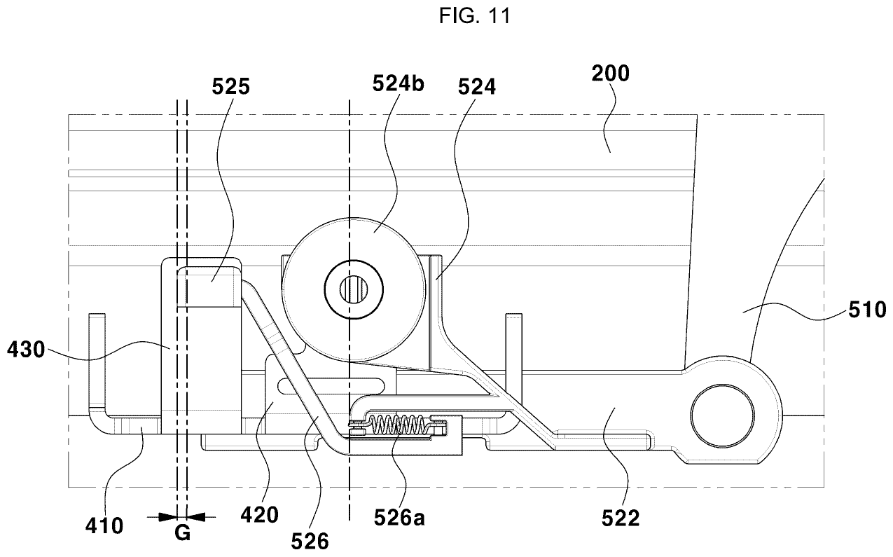

Specifically, since the second mounting portion 526 has a predetermined length and is made of an elastic material, the second mounting portion 526 may be deformed by external force. Accordingly, as shown in FIG. 10, when the first mounting portion 524 and the second mounting portion 526 are switched from the moving mode to the locking mode and are moved to be connected to the first support member 420 and the second support member 430, the second mounting portion 526 is additionally pressed by the roller member 524b. In this case, as shown in FIG. 11, the second mounting portion 526 is additionally moved by the elastic member 526a in a direction in which the elastic force is applied. That is, the second mounting portion 526 is moved along the inclined surface of the second support member 430 by a length of a gap G such that the horizontal clearance with respect to the upper rail 200 is effectively controlled.

As a result, in the present embodiment, the roller member 524b coupled to the first mounting portion 524 and the rubber member 525 coupled to the second mounting portion 526 are selectively connected to the first support member 420 and the second support member 430, respectively. In this manner, in the locking mode, a horizontal clearance and a vertical clearance of the guide bracket 520 with respect to the fixing guide 400 may be controlled to prevent vertical movement and horizontal movement of the upper rail 200. Accordingly, the occurrence of vibration and shaking of the upper rail 200 may be prevented, and marketability of a seat may be improved.

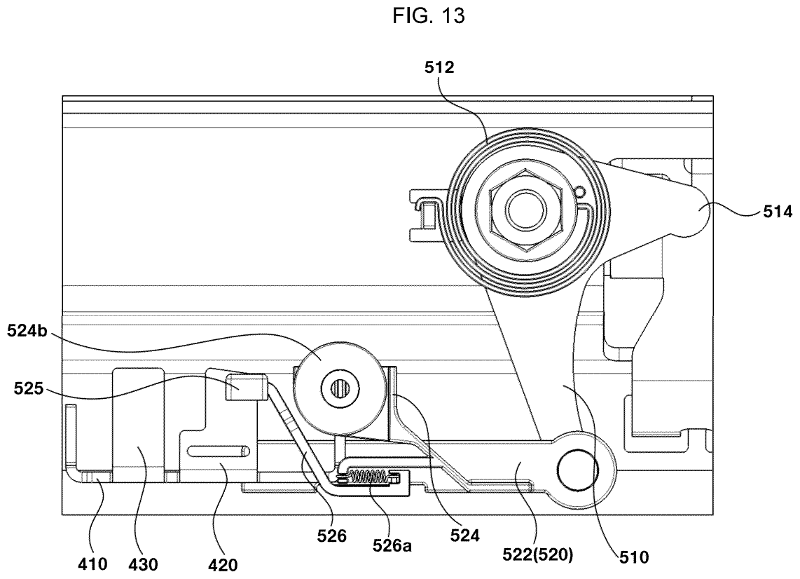

In addition, in the present embodiment, as shown in FIG. 13, when the locking module 300 is rotated according to switching from the locking mode to the moving mode, the guide bracket 520 is moved so as to be selectively disconnected from the fixing guide 400, and a space for the upper rail 200 to be moved along the lower rail 100 is secured. Accordingly, the upper rail 200 may be easily moved along the lower rail 100, and thus the occurrence of a difference in operating force due to movement of the upper rail 200 may be prevented.

According to the present disclosure, when a locking module is located to be caught by a lower rail, a rotation bracket is rotated by elastic force. Accordingly, a moving guide connected to the rotation bracket is slidably moved toward a fixing guide so as to be mounted on the fixing guide, and a vertical clearance and a horizontal clearance of an upper rail with respect to the lower rail are controlled by the shapes of the fixing guide, formed to be inclined in the vertical and horizontal directions, respectively. As a result, it is possible to achieve an effect of preventing vertical movement and horizontal movement of a seat in a fixed state.

Furthermore, in the present disclosure, a gap is formed between the lower rail and the upper rail so as to enable a seat to smoothly slide along the lower rail through the gap, and when the seat is fixed, gap occurrence is prevented by controlling a vertical clearance and a horizontal clearance through the rotation bracket, thereby having an effect of improving operating performance of the seat and marketability thereof.

As is apparent from the above description, the present disclosure provides a long slide rail system for a vehicle seat, configured to prevent vertical movement and horizontal movement of the vehicle seat in a fixed state in such a manner that a rotation bracket is rotated by elastic force when a locking module is located to be caught by a lower rail, a moving guide connected to the rotation bracket is slidably moved toward a fixing guide so as to be mounted on the fixing guide, and a vertical clearance and a horizontal clearance of an upper rail with respect to the lower rail are controlled by the shapes of the fixing guide, formed to be inclined in the vertical and horizontal directions, respectively.

Furthermore, in the present disclosure, a gap is formed between the lower rail and the upper rail so as to enable a seat to smoothly slide along the lower rail through the gap, and when the seat is fixed, gap occurrence is prevented by controlling a vertical clearance and a horizontal clearance through the rotation bracket, thereby having an effect of improving operating performance of the seat and marketability thereof.

What is claimed is:

1. A long slide rail system for a vehicle seat, the long slide rail system comprising:
a lower rail configured to extend lengthwise along a floor panel of a vehicle, the lower rail configured to be fixedly installed on the floor panel;
an upper rail coupled to the lower rail, the upper rail configured to enable a seat cushion to be slidably moved along the lower rail;
a locking module mounted on the upper rail, the upper rail being slidably movable based on the locking module being unlocked from a locking hole formed on the lower rail;
a fixing guide coupled to the upper rail so as to be spaced apart from the locking module; and
a moving guide coupled to the locking module and disposed to face the fixing guide, the moving guide being selectively connected to the fixing guide based on the locking module being locked on the locking hole so as to control a horizontal clearance and a vertical clearance with respect to the upper rail.

2. The long slide rail system of claim 1, wherein a pair of the fixing guides is provided in forward-and-rearward directions relative to the locking module.

3. The long slide rail system of claim 1, wherein the fixing guide is selectively provided either forwardly or rearwardly of the locking module.

4. The long slide rail system of claim 1, wherein the fixing guide comprises:
a main body fixedly coupled to the upper rail;
a pair of first support members formed to face each other, and to extend perpendicularly from the main body; and
a pair of second support members formed to substantially face each other, and to extend perpendicularly from the main body and disposed to be spaced apart lengthwise from the respective first support members.

5. The long slide rail system of claim 4, wherein each of the first support members has an upper surface formed to be inclined.

6. The long slide rail system of claim 4, wherein the second support members are disposed forwardly of the respective first support members in a forward direction of the moving guide and are disposed to be inclined such that a gap formed between the second support members gradually increases in the forward direction of the moving guide.

7. The long slide rail system of claim 4, wherein the moving guide comprises:
a rotation bracket configured to be rotatably coupled to the locking module so as to face the fixing guide; and
a guide bracket configured to be rotatably coupled to the rotation bracket,
wherein the guide bracket is configured to be selectively moved in conjunction with rotation of the rotation bracket so as to be connected to the first support members and the second support members.

8. The long slide rail system of claim 7, wherein the rotation bracket is configured to rotate in conjunction with rotation of the locking module upon the locking module being rotated to be unlocked from the locking hole, and is connected to the upper rail by an elastic member so as to elastically maintain a position of the guide bracket connected to the first support members and the second support members.

9. The long slide rail system of claim 8, wherein the rotation bracket comprises a protruding member formed to protrude toward the locking module.

10. The long slide rail system of claim 7, wherein the guide bracket comprises:
a body portion connected to the main body of the fixing guide, the body portion configured to be movable in forward-and-rearward directions;
first mounting portions disposed laterally of the body portion, the first mounting portions configured to be selectively connected to the respective first support members; and
second mounting portions connected to the body portion, the second mounting portions configured to be selectively connected to the respective second support members.

11. The long slide rail system of claim 10, wherein the first mounting portions comprise:
connecting members each formed to have an L-shape, the connecting members configured to support the respective first support members; and
roller members coupled to outer surfaces of the respective connecting members so as to contact an upper surface of the lower rail.

12. The long slide rail system of claim 11, wherein:
the second mounting portions are respectively connected to a left side and a right side of the body portion by elastic members and are configured to extend toward front sides of the respective first mounting portions, and
the second mounting portions are configured to be pressed by the respective roller members so as to be elastically moved in a direction that allows the second mounting portions to be connected to the respective second support members.

13. The long slide rail system of claim 10, wherein each of the second mounting portions comprises a rubber member coupled to an outer surface thereof so as to contact a side surface of the lower rail.

14. The long slide rail system of claim 10, wherein the body portion comprises an elastic member connected to the main body and disposed on a front side of the body portion, the elastic member configured to selectively provide, to the body portion, elastic restoring force in a compressed state based on the body portion being moved toward the fixing guide.
